(19) United States
(12) Patent Application Publication
(10) Pub. No.: US 2009/0145014 A1
(43) Pub. Date: Jun. 11, 2009

(54) Re-usable identification device

(76) Inventors: Cathy Lynn Homes, San Diego, CA (US); Margaret Ann Munoz, San Diego, CA (US)

Correspondence Address: X-PATENTS, APC, 5670 LA JOLLA BLVD., LA JOLLA, CA, 92037, US

(21) Appl. No.: 12/291,484

(22) Filed: Nov. 10, 2008

(51) Int. Cl. G09F 3/08

(52) U.S. Cl. 40/661.01

(57) ABSTRACT

An identification device for use on a container, comprising an identifying marker, a base magnet attached to said identifying marker, an attachment magnet adapted to be attracted to said base magnet wherein the overall energy density of said base magnet and said attachment magnet is sufficient to attach said identification device to said container.

### BACKGROUND OF THE INVENTION

1. Field of the Invention

The invention relates generally to the field of re-usable identification devices. In particular, the invention relates to devices used to identify the current user of glassware, or provide other information about an object in a variety of settings.

2. Description of Related Art

The problem of providing an identification device that can be used to identify the specific user of a particular object, such as glassware, in a large group setting has defied a practical solution. The prior art consists largely of devices such as traditional “wine charms” that can be placed around the stem of a glass or other item to be identified. Such devices suffer from a variety of drawbacks, as they are limited in their application to glassware with a clearly defined stem, they are often difficult to see, and they tend to slide along the stem when used.

The present invention overcomes these problems, providing an identification device that can be applied to a wide variety of different objects of varying thickness, regardless of shape, and which can be fixed in position, and used to provide easy identification of the particular user.

### SUMMARY OF THE INVENTION

An identification device for use on a container, display, or other object comprising an identifying marker, a base magnet attached to said identifying marker, and an attachment magnet adapted to be attracted to said base magnet, wherein the overall energy density of said base magnet and said attachment magnet is sufficient to attach said identification device to said container. Embodiments include the use of a rare earth magnet for the attachment and base magnets. In an embodiment of the invention, the energy density of said magnets is equal to or greater than BHmax=34. In an embodiment of the invention, the identifying marker is a pendant, tag or other object.

### BRIEF DESCRIPTION OF THE DRAWINGS

FIG. 1 is a diagram showing a side view of an exemplary identification device.

FIG. 2 is a diagram showing a side view of an exemplary identification device.

FIG. 3 is a diagram showing an exemplary identification device in use on glassware.

FIG. 4 is a diagram of an exemplary identification device.

FIG. 5 is a diagram showing a side view of the exemplary identification device of FIG. 4.

FIG. 6 is a diagram showing an examplary identification device in use on a vase.

### DETAILED DESCRIPTION OF THE PREFERRED EMBODIMENTS

The following description is presented to enable any person skilled in the art to make and use the invention. For purposes of explanation, specific nomenclature is set forth to provide a thorough understanding of the present invention. Descriptions of specific embodiments or applications are provided only as examples. Various modifications to the embodiments will be readily apparent to those skilled in the art, and general principles defined herein may be applied to other embodiments and applications without departing from the spirit and scope of the invention. Thus, the present invention is not intended to be limited to the embodiments shown, but is to be accorded the widest possible scope consistent with the principles and features disclosed herein.

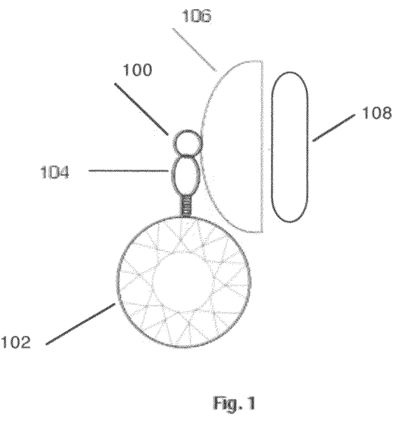

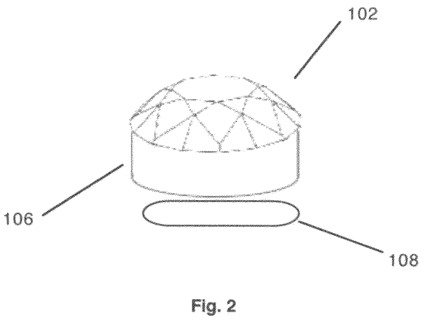

Referring to FIGS. 1 and 2, one embodiment of the invention consists of an identification device 100 comprising an identifying marker 102, an attachment structure 104, a base magnet 106, and an attachment magnet 108. Identifying marker 102 may be made from a wide variety of materials and may be fashioned into a wide variety of forms. The function of the identifying marker is simply to be distinguishable from other identifying markers in a given group. As shown in FIG. 1, the identifying marker takes the form of a pendant. Common identifying markers include real or artificial semi-precious stone, glass beads, crystals of various shapes, colors, and sizes, plastic or metal pendants with different finishes, etc. The identifying markers in a particular set may typically comprise variations of the same shape or material that can be easily distinguished by the user. While the decorative identifier shown in FIG. 1 takes the form of a pendant, referring now to FIG. 2, the decorative identifier 102 may also take the form of a stud or other structure.

Attachment structure 104 may comprise a separate structure such as a metal cap or other structure that provides a point of attachment for base magnet 106. Attachment to the base magnet may be accomplished by any suitable means such as a bar, wire, or adhesive such as glue or epoxy. Such a separate structure may be attached to an identifying marker 102 or other identifying tag by means of any suitable connection device, including without limitation bars, hooks, loops, clips, headpins, wire, string, glue, adhesives, solder, etc. The attachment structure also may be integrated into identifying marker 102, such that no such connection device is required.

Base magnet 106 may comprise a magnet of a variety of types. In one embodiment, base magnet 106 comprises a rare earth magnet such as a Neodymium Iron Boron or Samarium Cobalt magnet. Such magnets are generally advantageous based on their relative strength across the relevant temperature ranges and resistance to de-magetization. Ceramic or ferrite magnets may also be used effectively, and may be preferable where the shape or size of the magnet must be controlled.

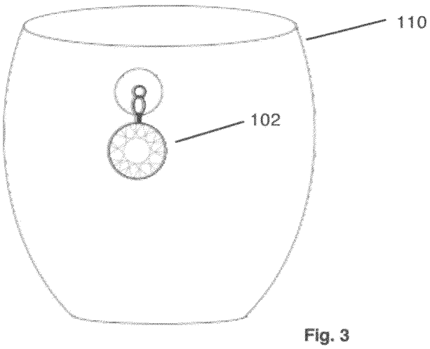

Attachment magnet 108 similarly may comprise a magnet of a variety of types depending on the specific application. As seen in FIG. 3, the identification device 100 of this invention may be attached to a container such as glassware 110 by placing the base magnet 106 at the selected point of attachment on the container, and placing the attachment magnet 108 on the opposing side of the container material such that the magnetic attraction between the base magnet 106 and the attachment magnet 108 holds the identification device in place. Attachment magnet 108 may be optimally sized to be small and inconspicuous, while providing sufficient holding force to retain the identification device on the object. If the container to which the identifying marker is to be attached is metal, the identifying marker can be attached directly to the item without the need for an attachment magnet.

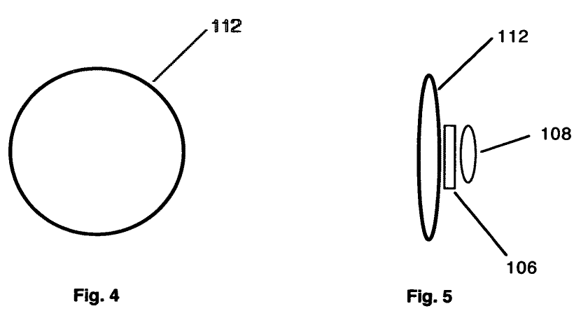

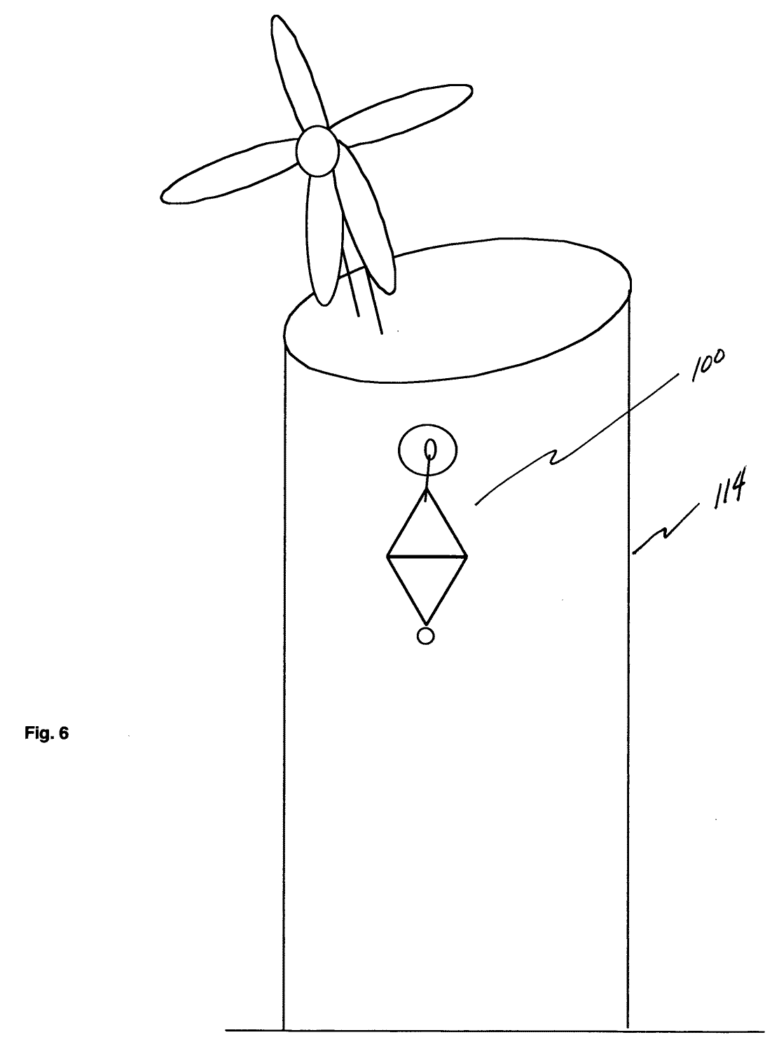

Referring to FIGS. 4 and 5, another embodiment of the invention consists of an identification device 100 comprising an identifying marker in the form of an identification tag 112, a base magnet 106, and an attachment magnet 108. Identification tag 112 may be made of a wide variety of materials, including metal, plastic, wood, glass, resin, or virtually any other material that can be formed into a usable shape for attachment. In one embodiment, the identification tag is made of a material that will absorb ink from various types of pens or markers such that identifying marks can be made on the identification tag. In another embodiment, the identification tag is made of a material that can be erasably marked, such that temporary identifying marks can be made on the identification tag and later modified or erased.

As noted above, the base magnet 106 and attachment magnet 108 preferably comprise a strong, permanent magnet with sufficient strength to hold the identification device on the object. These requirements may be satisfied by rare earth magnets of appropriate size and orientation. The overall energy density (BHmax) of the magnets when used to attach to glassware, will optimally be equal or greater than 34, although lower energy densities may be sufficient for particular applications. Both magnets may be resistant to degradation due to fluctuations in temperature and moisture levels. Examples of rare earth magnets having appropriate magnetic properties include Neodymium-Iron-Boron (Nd—Fe—B) Magnets, such as nickel-coated grade N-35 Nd—Fe—B magnets. The base magnet and attachment magnet may be any appropriate size and thickness suitable for the particular application. For attachment to glassware, appropriate sized range from 6 to 8 mm in diameter and from 1 to 2 mm in thickness.

Referring to FIGS. 3 and 6, identification devices as disclosed herein may be used in a wide variety of applications, including without limitation for identification of glassware, containers for flowers or gifts such as vases 114 and gift baskets, party favors or gift bags, items in or on a display background, dinnerware, decorative vessels, candleholders, holiday displays; planters, gifts, or virtually any other object. The identification devices as disclosed herein may also be used to provide other information about a vessel or object, such as price, product characteristics, or other information.

What is claimed is:

1. An identification device for use on a container, comprising:
an identifying marker;
a base magnet attached to said identifying marker;
an attachment magnet adapted to be attracted to said base magnet;
wherein the overall energy density of said base magnet and said attachment magnet is sufficient to attach said identification device to said container.

2. The apparatus of claim 1, wherein said base magnet comprises a rare earth magnet.

3. The apparatus of claim 1, wherein the attachment magnet comprises a rare earth magnet.

4. The apparatus of claim 1, wherein the overall energy density of the base magnet and attachment magnet is equal to or greater than BHmax=34.

5. The apparatus of claim 1, wherein said identifying marker is a pendant.

6. The apparatus of claim 5, wherein said pendant comprises a semi-precious stone.

7. The apparatus of claim 1, wherein said identifying marker is a tag.

8. The apparatus of claim 7, wherein said tag comprises a material that can be written on.

9. An identification device for use on a display, comprising:
an identifying marker;
a base magnet attached to said identifying marker;
an attachment magnet adapted to be attracted to said base magnet;
wherein the overall energy density of said base magnet and said attachment magnet is sufficient to attach said identification device to said display.

10. The apparatus of claim 9, wherein said base magnet comprises a rare earth magnet.

11. The apparatus of claim 9, wherein the attachment magnet comprises a rare earth magnet.

12. The apparatus of claim 9, wherein the overall energy density of the base magnet and attachment magnet is equal to or greater than BHmax=34.

13. The apparatus of claim 9, wherein said identifying marker is a pendant.

14. The apparatus of claim 13, wherein said pendant comprises a semi-precious stone.

15. The apparatus of claim 9, wherein said identifying marker is a tag.

16. The apparatus of claim 15, wherein said tag comprises a material that can be written on.
